(19) United States
(12) Patent Application Publication
(10) Pub. No.: US 2024/0258023 A1
(43) Pub. Date: Aug. 1, 2024

(54) CONDUCTIVE MATERIALS IN ALTERNATING MAGNETIC FIELDS

(71) Applicant: Resonant Link, Inc., South Burlington, VT (US)

(72) Inventors: Aaron Stein, Essex, VT (US); Phyo Aung Kyaw, Winooski, VT (US); Grayson Zulauf, Palo Alto, CA (US)

(73) Assignee: Resonant Link, Inc., South Burlington, VT (US)

(21) Appl. No.: 18/633,054

(22) Filed: Apr. 11, 2024

Related U.S. Application Data
(63) Continuation of application No. PCT/US2022/048870, filed on Nov. 3, 2022.
(60) Provisional application No. 63/275,555, filed on Nov. 4, 2021.

(51) Int. Cl. H01F 27/36; H01F 27/00; H01F 27/24; H01F 27/32; H01F 27/34

(52) U.S. Cl. CPC H01F 27/363; H01F 27/006; H01F 27/24; H01F 27/323; H01F 2027/348

(57) ABSTRACT

An electromagnetic component includes at least one winding having one or more turns and at least one conductor disposed in a location where the at least one winding produces an alternating magnetic field. The at least one conductor has at least one gap that inhibits current from flowing a full turn through the at least one conductor.

### RELATED APPLICATIONS

This application is a Continuation of International Patent Application Serial No. PCT/US2022/048870, filed Nov. 3, 2022, titled “CONDUCTIVE MATERIALS IN ALTERNATING MAGNETIC FIELDS”, which claims the benefit of U.S. Provisional Application Ser. No. 63/275,555, filed Nov. 4, 2021, titled “GAPPED CONDUCTORS FOR MULTI-TURN WINDINGS,” each of which is incorporated herein by reference in its entirety.

### BACKGROUND

### 1. Technical Field

The present disclosure relates to structures and techniques for reducing eddy currents in conductors disposed within an alternating magnetic field.

### 2. Discussion of the Related Art

Electromagnetic components, including but not limited to wireless power transfer coils, inductors and transformers, may include one or more windings. In many applications, it would be advantageous to improve efficiency by minimizing power losses associated with electromagnetic components.

### SUMMARY

An electromagnetic component includes at least one winding having one or more turns and at least one conductor disposed in a location where the at least one winding produces an alternating magnetic field. The at least one conductor has at least one gap that inhibits current from flowing a full turn through the at least one conductor.

The one or more turns may comprise a first turn around an axis and a second turn around the axis and the first turn.

The one or more turns may have a spiral shape.

The at least one conductor may cover at least a portion of the at least one winding.

The at least one conductor may cover at least 75% of the at least one winding.

The at least one conductor may cover at least 90% of the at least one winding.

The at least one conductor may have approximately a planar shape.

The one or more turns may have a cylindrical shape.

The one or more turns may have a helical shape.

The at least one conductor may have approximately a cylindrical shape.

A distance between the at least one conductor and the at least one winding may be between 1 nanometer and 25 micrometers, between 25 micrometers and 200 micrometers, or between 200 micrometers and 1 centimeter.

The at least one conductor may have a thickness approximately equal to an electromagnetic skin depth of the at least one conductor at a fundamental frequency of operation of the electromagnetic component.

The at least one winding may comprise wire, magnet wire, stranded wire, litz wire, printed circuit board traces, conductors laminated on a substrate, foil layers, multilayer self-resonant structures, modified multilayer self-resonant structures, low-frequency self-resonant structures, solid metal, or a combination thereof.

The electromagnetic component may further comprise a magnetic core.

The at least one winding may be within the magnetic core.

The magnetic core may have a magnetic flux gap and the at least one conductor may be between the at least one winding and the gap.

The magnetic core may comprise a center post, an outer rim, a backplate, or any combination thereof.

The at least one gap may comprise a plurality of gaps.

A longest dimension of the at least one gap may be approximately perpendicular to a winding direction of the at least one winding at a location of the at least one winding nearest the at least one gap.

The at least one conductor may comprise at least one first conductor on a first side of the at least one winding, the at least one first conductor having at least one first gap, and at least one second conductor on a second side of the at least one winding, the at least one second conductor having at least one second gap.

The at least one first conductor may be in a region of lower magnetic field than that of the at least one second conductor.

The at least one first conductor may be closer to a backplate of the magnetic core than the at least one second conductor.

The at least one first conductor may be thicker than the at least one second conductor.

A thickness of the at least one first conductor may be greater than an electromagnetic skin depth of the at least one first conductor at a fundamental frequency of operation of the electromagnetic component.

A thickness of the at least one second conductor may be less than the electromagnetic skin depth of the at least one first conductor at a fundamental frequency of operation of the electromagnetic component.

The at least one winding may be formed in a plurality of layers with an integrated capacitance between respective portions of the at least one winding in respective layers of the plurality of layers.

The at least one winding may be connected to a capacitive impedance.

The electromagnetic component may comprise an inductor, transformer, or wireless power transfer coil.

An electromagnetic component includes at least one winding having a one or more turns around an axis. The least one conductor at least partially covers the at least one winding. The at least one conductor includes at least one high-resistance region that inhibits current from flowing a full turn around the axis through the at least one conductor.

The at least one high-resistance region may comprise at least one region separating respective portions of the at least one conductor.

The at least one high-resistance region may includes an insulator having an electrical conductivity less than 100 kS/m.

The at least one conductor may above the at least one winding, below the at least one winding, or the at least one conductor may comprise a first conductor below the at least one winding and a second conductor above the at least one winding.

The electromagnetic component may further comprise an electrical insulator separating the at least one winding from the at least one conductor.

The at least one conductor may be configured to provide mechanical support for a vehicle.

Some aspects relate to a method of manufacturing or operating an electromagnetic component as described in the present description or claims.

A method of operating an electromagnetic component may comprise operating the electromagnetic component an operating frequency.

The foregoing summary is provided by way of illustration and is not intended to be limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIGS. 1A-1D show examples of an electromagnetic component in which a winding is within a magnetic core and a gapped conductor is placed in a region of high magnetic field above the winding and magnetic core.

FIGS. 2A-2C show an example of an electromagnetic component in which a winding is within a magnetic core and a gapped conductor is positioned between the winding and the magnetic core. FIGS. 2D-2F show an example of an electromagnetic component in which the gapped conductor is positioned above the winding.

FIGS. 3A and 3B show an example of an electromagnetic component having a gapped conductor above the winding and a gapped conductor below the winding.

FIGS. 4A and 4B show an electromagnetic component on which tests were performed.

FIGS. 5A and 5B illustrate an electromagnetic component similar to the electromagnetic component of FIGS. 3A-3B, with gapped conductors on either side of winding, but without a magnetic core.

FIGS. 6A and 6B show a side view and cutaway view, respectively, of an electromagnetic component in which a winding has a helical shape.

FIGS. 7A and 7B show a side view and cutaway view, respectively, of an electromagnetic component in which a winding is wrapped around a center post of a magnetic core.

### DETAILED DESCRIPTION

As mentioned above, electromagnetic components, including but not limited to wireless power transfer coils, inductors and transformers, may be include one or more windings. In some applications, the shape of electric and/or magnetic fields generated by a winding may be undesirable. For example, time-varying magnetic fields may induce eddy currents in conductors, which causes power loss. As another example, reducing the electric field present outside an electromagnetic component may be desirable for applications in which the electromagnetic component is implanted within or in close proximity to humans or animals.

The inventors have developed structures and related techniques that can shape electromagnetic fields near a winding without generating excessive eddy current loss. One such structure is termed a gapped conductor. A gapped conductor includes one or more electrical conductors extending with one or more gaps to prevent or impede a complete current loop from forming around the axis through the gapped conductor. A gapped conductor may have a gap in which the conductor is absent or in which a region of relatively high resistance is formed by a thinned conductor and/or a material of high electrical resistivity. A gapped conductor may be disposed adjacent to or approximately adjacent to a one or more windings. A gapped conductor may significantly reduce loss or mitigate unwanted electromagnetic fields by shaping electromagnetic fields near the windings.

A winding is a path of electrically conductive material that forms one or more complete turns around an axis. The winding may be of any shape and size and may have any number of turns. A winding generates an electromagnetic field, which may be useful for a variety of applications such as wireless power transfer through electromagnetic induction, or for use in other electromagnetic components such as inductors or transformers, for example. A winding or individual turns of a winding may be connected to a capacitive element, such as one or more standalone (e.g., discrete) capacitors. Alternatively, or additionally, a winding may have an integrated capacitance formed between respective layers of the winding, as in a multilayer self-resonant structure (MSRS), for example. A plurality of windings may be present in some types of electromagnetic components, such as transformers, for example. The techniques described herein are applicable to any electromagnetic components, and are not limited to the aforementioned applications.

One or more gapped conductors placed near one or more windings may shape the electromagnetic field to be more uniform in the approximate region of the one or more windings, resulting in a lower power loss. Furthermore, one or more gapped conductors, placed near the one or more windings, may reduce the electric field near the one or more windings. The gapped conductor may be of any suitable shape. The gapped conductor may cover all or any portion of the winding, such as 75% or more, or 90% or more of the area of the winding.

A gapped conductor may have one gap or more than one gap. The gap(s) may have any shape or size. The gaps may be only large enough to ensure that current cannot flow through the gap, or may be larger. Any orientation of the gap in the conductor layer relative to the winding may result in reduction of eddy current, hence power loss, and the electric field near the winding(s). Optionally, orienting the gap in the conductor layer in a manner similar to that of the winding may result in an optimal reduction of eddy current and electric field.

In some embodiments, a gapped conductor may be galvanically isolated from the one or more windings. An electrically insulating material may separate the gapped conductor(s) from the winding(s). The electrically insulating material may be any suitable electrically insulating material, such as a solid material (e.g., a polymer, ceramic, composite, etc.) or a gas (e.g., air), or a combination of insulating materials. In some embodiments, one or more gapped conductors may be galvanically connected to one or more windings at a suitable location.

A gapped conductor and a winding may be separated from one another by any distance. In some embodiments, the gapped conductors may be positioned close to the one or more windings—for example, a 25 micrometer separation or less, such as between 1 nm and 25 micrometers—for significant shielding and electromagnetic field shaping effects. In some embodiments, a gapped conductor may be positioned farther from the one or more windings—for example, a 200 micrometer separation or more, such as between 200 micrometers and 1 centimeter or 10 centimeters—in order to reduce the parasitic capacitance between the gapped conductor and the winding(s). In some embodiments, the separation between the gapped conductor and the winding may be of a medium separation—for example, 25 to 200 micrometers—in order to balance the reduced electromagnetic field shield effect with the higher parasitic capacitance.

A gapped conductor may be placed between the winding(s) and surrounding environment, or between layers of the winding(s). When a gapped conductor is placed between the winding(s) and the surrounding environment, the gapped conductor may reduce induced electromagnetic field in the surroundings environment, while at the same time shaping the magnetic field in the region of the winding(s) to reduce eddy currents. In some embodiments where the winding is placed near a magnetic core, a conductor layer may separate the winding from the magnetic core, thereby reducing leakage magnetic flux in the region of the winding. In some other embodiments, the winding may be placed near a gapped magnetic core. In these embodiments, a conductor layer may be placed between the winding and the gapped magnetic core, near the gap in the magnetic core, resulting in a reduced magnetic flux in the region of the winding, hence reduced eddy current loss.

In some embodiments, winding(s) may be formed in a plurality of layers. Gapped conductor(s) placed between respective layers of windings may help to shape the electromagnetic field to be more parallel to the windings, thus reducing loss.

The gapped conductors may have any thickness. Optionally, the gapped conductors may have a thickness approximately equal to the skin depth of the conductor at the frequency of operation. A thickness greater than half the skin depth may be beneficial for at least partially blocking electromagnetic fields. To allow electromagnetic fields to pass through, the thickness may be less than half a skin depth. When an electromagnetic component includes a plurality of gapped conductors, the thickness of the gapped conductors may be the same or different. In some embodiments, a thicker conductor may be used in regions of relatively low magnetic field around the winding while a thinner conductor may be used in regions of relatively high magnetic field around the winding; such difference in the conductor thickness based on the intensity of the magnetic field may result in lower induced loss in the gapped conductors. In some embodiments, multiple thin gapped conductors, each optionally separated by a layer of electrically insulating material, may be used in place of a thick gapped conductor; in such embodiments, the gaps in the conductor layer(s) may optionally be oriented similarly such that the gaps approximately align with one another.

Gapped conductor(s) can be included in any electromagnetic component with at least one winding. The winding may be made of any shape and size of any electrically conductive materials. The winding may also be of any shape, such as spiral, helix, multi-layer winding, and toroid, among others. The gapped conductors may also be of any shape and size, optionally of similar geometry as the enveloping surface the winding; in some embodiments, the gapped conductors may be made of one gapped conductor layer while in some other embodiments, the gapped conductors may be made of a plurality of gapped conductor layers.

The inventors have recognized the distance between a gapped conductor and a winding may have an effect on performance. If the gapped conductor is too far away, the gapped conductor may not adequately shield the winding. If the gapped conductor is too close, then parasitic capacitance may decrease the quality factor of the electromagnetic component. In some embodiments, the distance between a conductor and a winding may be between 25 and 125 micrometers. However, in other embodiments the distance may be smaller or larger. An electrically insulating layer between the winding and the conductor may be used to galvanically isolate part or all of the gapped conductor and control the distance between the winding and the gapped conductor. The separation between the gapped conductor and the winding may vary at different locations of the winding. In some embodiments, the gapped conductor may galvanically connect to the winding in at least one area.

A winding in the form of a spiral conductor in a magnetic core, which is commonly used for wireless power transfer, may benefit from one or more gapped conductors. However, the electromagnetic components described herein are not limited to those designed for performing wireless power transfer.

In some applications, a conductor may be placed in an area having a high magnetic field. For example, a wireless power transfer coil may be placed at or below ground level to facilitate wireless charging of a rechargeable electric or hybrid electric vehicle. The term “vehicle” is not limited to automotive vehicles that can be driven on the road, and instead relates to any mobile conveyances that may be at least partially battery-powered such as vehicles driven in factories, robots, robotic, autonomous or semi-autonomous vehicles, carts, etc. A grate or lid may be placed over the wireless power transfer coil to allow a vehicle to drive over it without damage. Such a grate or lid may be formed of metal or another conductive material, which may be susceptible to eddy currents forming due to the position of the conductive material in a region of high magnetic field. Other examples of applications in which a conductive material may be placed in a region of high magnetic field include applications where wireless transfer is performed through a wall or other barrier, such as a metal case of an implant. Another example of such an application is one where there is limited space, and magnetics are tightly integrated with electronics and one or more coils (e.g., wireless power transfer coils): a gapped conductor may be used to shield the electronics from the field produced by the coil(s).

Eddy currents may be reduced or eliminated by impeding current paths through the conductive material. To impede the current paths, a gap may be provided in the conductive material to prevent a complete current path from forming through the conductive material around an axis (e.g., a central axis). The gap may be a region having high electrical resistance, and may be realized in a variety ways such as an absence of solid material (e.g., an air-gap), a material of high electrical resistivity, or a thinned region of conductive material.

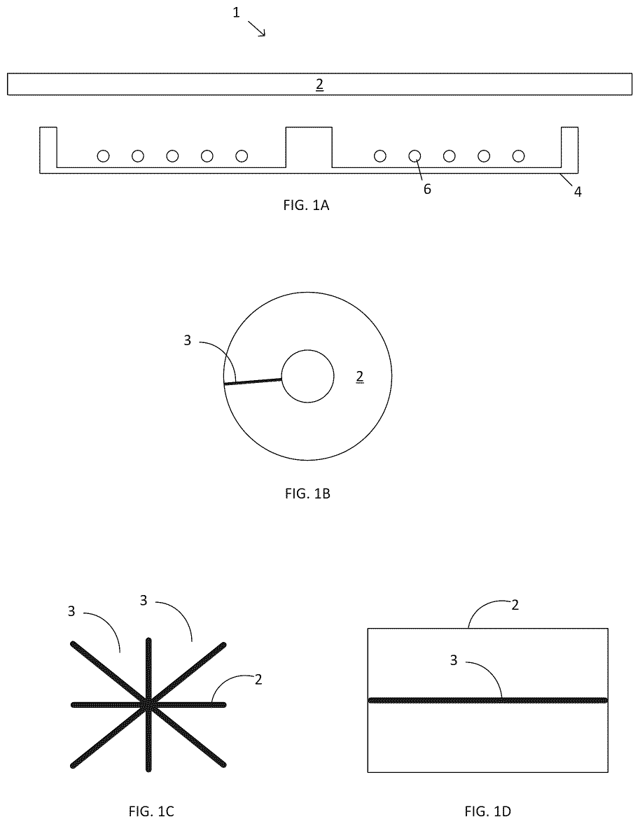

FIG. 1A shows an example of an electromagnetic component 1 in which a winding 6 is within a magnetic core 4 and a gapped conductor 2 is placed in a region of high magnetic field above the winding 6 and magnetic core 4. As mentioned above, the gapped conductor 2 may be a support structure, such as a lid or grate, for example, to allow a rechargeable vehicle to securely drive over the winding 6, or the gapped conductor 2 may be included in another barrier such as a case or wall. Winding 6 is illustrating as having five turns, but this is an example, and a winding 6 may have any number of one or more turns. In some embodiments, the electromagnetic component may include a winding 6 and no magnetic core 4.

The gapped conductor 2 may take a variety of different shapes in different applications. FIG. 1B shows a top view of an example in which the gapped conductor 2 has a washer-shape or a C-shape, approximately corresponding to a shape of the winding 6 in top-view. A gap 3 electrically isolates portions of the gapped conductor 3, and prevents or impedes eddy currents from flowing through the gapped conductor 2 through a complete revolution about the central axis of electromagnetic component 1. FIG. 1C shows a top view of another example in which the gapped conductor 2 has a plurality of spokes separated respective gaps 3, which in this example are eight wedge-shaped gaps, though the gaps may be present in any shape and number. FIG. 1D shows a top view of another example in which the gapped conductor 2 has a rectangular shape and a gap 3 that extends across a dimension of gapped conductor 2.

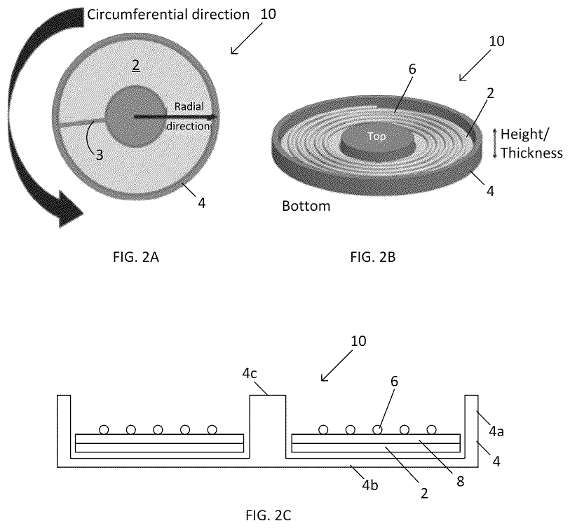

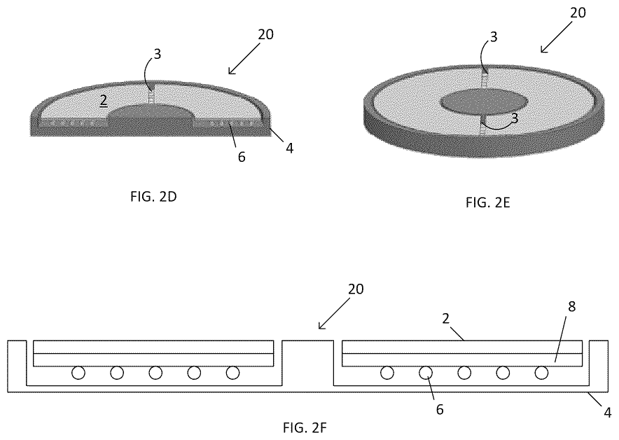

FIGS. 2A-2C show an example of an electromagnetic component 10 in which a winding 6 is within a magnetic core 4 and a gapped conductor 2 is positioned between the winding 6 and the magnetic core 4. FIG. 2A shows a top view of the electromagnetic component 10 without the winding 6 to illustrate the gapped conductor 2. FIG. 2B shows a perspective view of the electromagnetic component 10. FIG. 2C shows a side view of the electromagnetic component 10 and shows that an electrical insulator 8 may be positioned between the winding 6 and the gapped conductor 2 to electrically isolate them from one another. FIG. 2C also shows the magnetic core 4 may be a pot core with an outer rim 4a, a backplate 4b and a center post 4c. However, this is an example, and the magnetic cores described herein are not limited to pot cores. The winding 6 has five turns in this example. However, a winding may have any number of one or more turns. The winding 6 is illustrated as being a wire in this example. However, the winding 6 may be formed of any of a variety of conductors, other examples of which are descried herein. In this example, the gapped conductor 2 resembles a C shape and has a single gap 3. The size of the gap 3 need only be large enough to prevent or impede current from forming a complete loop around the gapped conductor 2. Increasing the gap size may reduce the effectiveness of the gapped conductor 2. However, larger gap sizes may also be effective. The gapped conductors described hercin are not limited as to the size of the gap.

A gapped conductor 2 placed between the magnetic core 4 and the winding 6 may drastically reduce proximity effect loss in the winding 6. The gapped conductor 2 may mitigate the vertical component of the magnetic field and therefore drastically reduce proximity effect in the winding 6. In the example of FIGS. 2A-2C, the gapped conductor is located near the backplate 4b of magnetic core 4, which is a region with a relatively low magnetic field. Since the magnetic field in this region is low, the thickness of the gapped conductor 2 may be relatively large without incurring significant losses. Optionally, the thickness of the gapped conductor 2 at this location may be larger than the skin depth of the conductor used in the gapped conductor 2 at the operating frequency of the electromagnetic component. However, the thickness of the gapped conductor 2 is not limited to any particular value.

In some embodiments, the gap 3 may be approximately circumferentially aligned (within 30 degrees, or within 15 degrees) with one or more leads of the winding 6, which may reduce loss in the gapped conductor 2. However, the gap 3 may have any orientation.

In some embodiments, a gapped conductor may be positioned above a winding. A gapped conductor placed above the winding may proximity effect loss in the spiral winding. Alternatively or additionally, a gapped conductor positioned above a winding may shield the environment from the electric field generated by the turn-to-turn electric potential difference within a winding. FIGS. 2D-2F show an example of an electromagnetic component 20 in which the gapped conductor 2 is positioned above the winding 6. FIG. 2D illustrates the gapped conductor 2 may have a single gap 3, while FIG. 2E illustrates the gapped conductor may have a plurality of gaps 3 at different circumferential locations. In the example of FIG. 2E, the gaps 3 are equally spaced approximately 180 degrees apart from one another. However, a plurality of gaps may have any positions or spacing. FIG. 2F shows a side view illustrating the gapped conductor 2 may be positioned near or at the top of the magnetic core 4, which in this example is a pot core. In this location, the gapped conductor 2 is within a relatively high magnetic field region. To reduce loss, a gapped conductor 2 positioned in a region of relatively high magnetic field may have a relatively small thickness. Optionally, the thickness of the gapped conductor 2 may be smaller than the skin depth of the gapped conductor 2 at the frequency of operation of the electromagnetic component to mitigate eddy current loss. However, this is an example, and the gapped conductor 2 may have a different thickness. Again, the distance between the gapped conductor 2 and the winding 6 may be controlled using electrically insulating layer 8.

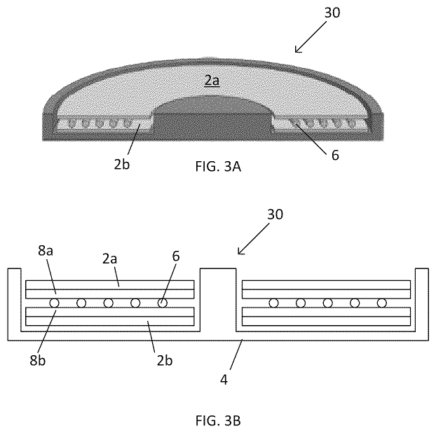

In some embodiments, a first gapped conductor may be located on one side of a winding and second gapped conductor may be located on a second side of a winding. FIGS. 3A and 3B show an example of an electromagnetic component 30 having a gapped conductor 2a above winding 6 and a gapped conductor 2b below winding 6. The gapped conductors 2a and 2b may be separated from the winding 6 by respective insulating layers 8a and 8b. Positioning gapped conductors on both sides of a winding may significantly reduce eddy currents in the winding and mitigate the electric field outside of the component.

The gapped conductors 2a and 2b may have the same thicknesses or different thicknesses. In the example of FIGS. 3A and 3B, the gapped conductor 2a is in a region of relatively high magnetic field and the gapped conductor 2b is in a region of relatively low magnetic field. Accordingly, the gapped conductor 2b may be thicker than the gapped conductor 2a due to the lower magnetic field near gapped conductor 2b, which is less susceptible to the proximity effect. For example, the gapped conductor 2b may have a thickness larger than that of an electromagnetic skin depth in gapped conductor 2b at the frequency of operation of electromagnetic component 30. The gapped conductor 2a may have a thickness smaller than that of an electromagnetic skin depth, or smaller than 1/10^{th} or 1/100^{th} of the skin depth in gapped conductor 2a at the frequency of operation of electromagnetic component 30.

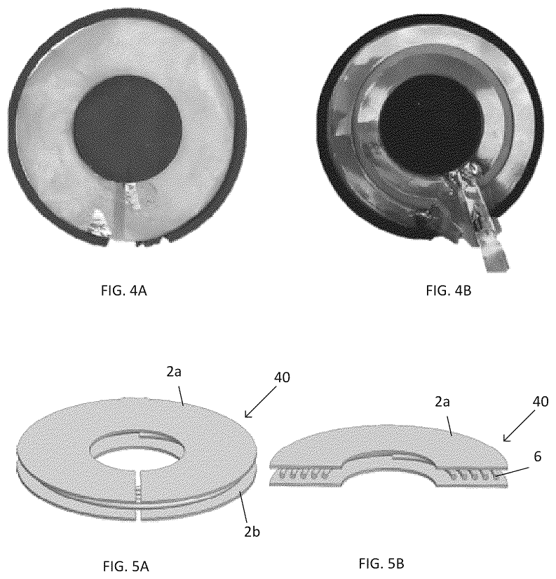

Experiments have been conducted that validate the benefits of gapped conductors. A ferrite core pot core with 6.6 cm and 9 cm diameter were used for testing. An example gapped conductor, shown in FIG. 4A, was placed in various locations: in the bottom of the magnetic core, on top of the winding, or similar gapped conductors were positioned both above and below the winding. The gap in the gapped conductor was oriented approximately in the same circumferential position as the leads of the winding. The two-turn foil winding used for testing is shown in FIG. 4B. A sheet of polytetrafluoroethylene (PTFE) film was used to separate the winding from the gapped conductor. The performance was measured and the results are shown in Table 1. Measurements showed a 26.2-78.5% reduction in loss due to the gapped conductors.

TABLE 1

| Magnetic | | | Gapped | | |
|---|---|---|---|---|---|
| Core | | Gapped | conductor | | |
| Diameter | Winding | conductor | Thickness | Quality | Percent |
| (mm) | Turns | Location(s) | (μm) | Factor | Improvement |
| 66 | 2 | None | None | 307 | — |
| 66 | 2 | Bottom | 12.5 | 464 | 51% |
| 66 | 2 | Bottom | 25 | 548 | 78.5% |
| 66 | 2 | Bottom, Top | 25 | 463 | 51% |
| 90 | 3 | None | None | 581 | — |
| 90 | 3 | Bottom | 25 | 792 | 36% |
| 90 | 6 | None | None | 301 | |
| 90 | 6 | Bottom, Top | 25, 12.5 | 386 | 26.2% |

Above has been described examples of electromagnetic components with a winding disposed in a magnetic core. In some embodiments, an electromagnetic component does not include a magnetic core. FIGS. 5A and 5B illustrate an electromagnetic component 40 similar to that electromagnetic component 30 of FIGS. 3A-3B, with gapped conductors 2a and 2b on either side of winding 6, but without a magnetic core. Gapped conductors 2a and 2b may shape the magnetic field to be parallel to the gapped conductors, thereby minimizing or otherwise reducing the eddy current loss induced in the winding. Alternatively or additionally, the gapped conductors 2a, 2b may reduce the electric field induced in the approximate surroundings of the winding due to the turn-to-turn electric potential difference.

In some embodiments only one gapped conductor may be present, either on one side of the winding or the other side. For example, in an application of wireless charging electric vehicles or other mobile equipment, a winding may be disposed below ground level. The area beneath the winding may be inaccessible, and thus not amenable to the addition of a gapped conductor below the winding. In such an application, a gapped conductor may be placed above the winding.

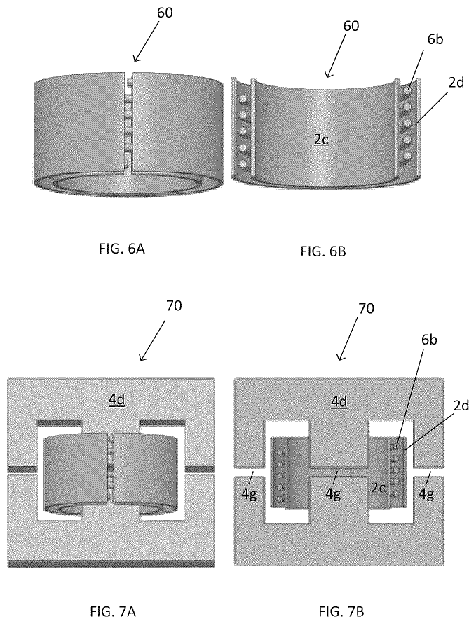

In some embodiments, a winding may conform to a cylindrical geometry, such as when a winding is wrapped around a mandrel. For example, a winding may have approximately a helical shape. FIGS. 6A and 6B show a side view and cutaway view, respectively, of an electromagnetic component 60 in which a winding 6b has a helical shape. In this example winding 6b has five turns. However, as mentioned above, the windings described herein may have any number of two or more turns. Gapped conductors 2c and 2d are located on the inner side and the outer side of winding 6b, and may be separated therefrom by an optional insulating layer. Gapped conductors 2c and 2d have approximately a cylindrical shape. Each of gapped conductors 2c and 2d may have a gap 3, which in this example has a longest dimension in the vertical direction of FIGS. 6A and 6B, approximately perpendicular to the circumferential direction in which winding 6b is wound. Each gapped conductor may have a single gap, as shown in FIG. 6A or a plurality of gaps. The gapped conductors 2c and 2d may shape the magnetic field in the winding to be parallel to the gapped conductors 2c and 2d. The gapped conductor 2d may reduce the electric field due to the turn-to-turn electric potential in the surroundings near the winding 6. Although electromagnetic component 60 is shown to have two gapped conductors 2c and 2d, in some embodiments an electromagnetic component may include cither 2c or gapped conductor 2d instead of both gapped conductors 2c and 2d.

One or more windings optionally may be wrapped around a magnetic core. FIGS. 7A and 7B show a side view and cutaway view, respectively, of an electromagnetic component 70 in which a winding 6b is wrapped around a center post of a magnetic core 4d. In this example magnetic core 4 is an E-core. However, any type of core may be used. The inclusion of gapped conductors 2c and/or 2d may allow winding 6b to be placed closer to a magnetic flux gap 4g in the magnetic core without excessive loss than would be the case without the gapped conductor(s), thereby increasing the usable winding space. In some embodiments, a gapped conductor may be shaped to approximately follow the shape of the magnetic field lines near the magnetic flux gap 4g in the magnetic core to minimize loss. In some versions of such embodiments, the gapped conductors may be applied to electromagnetic structures with more than one windings.

In some embodiments, an electromagnetic component may include a plurality of windings. One or more of the windings may have one or more gapped conductors for the corresponding winding. For example, a transformer, coupled inductors, or another magnetic circuit may be formed using a plurality of windings 6b, and each of windings 6b may have corresponding gapped conductors 2c and/or 2d. Alternatively, the windings of a transformer may have a planar geometry, as in the example of FIGS. 5A and 5B.

The winding and any other conductor or conductive layer, including a gapped conductor, may be, wholly or partially, made of electrically conductive materials including but not limited to one or more metals such as silver, copper, aluminum or gold. The electrically conductive material of the winding or gapped conductor may have an electrical conductivity of higher than 200 kS/m, optionally higher than 1 MS/m. The winding may be constructed, but not limited to, using wire, magnet wire, stranded wire, litz wire, printed circuit board traces, conductors laminated on a substrate, foil layers, multilayer self-resonant structures, modified multilayer self-resonant structures, low-frequency self-resonant structures, solid metal, or any combination of them. The winding may have capacitance which is intentional or parasitic. The techniques and devices described herein are not limited to a particular winding material construction, or shape.

Conductor layers or electrical conductor layers, are electrical conductors in which the size of the conductor along one dimension is much smaller (e.g. at least 10 times smaller) than the size of the conductor along the other two orthogonal dimensions. Some examples for foil conductors may include, but are not limited to, foil layers forming a flat current loop (e.g. C-shaped, arc-shaped, rectangular-shaped, or any polygon-shaped conductors); foil layers wrapped around a cylinder or prism; barrel-wound and edge-wound conductors; and/or toroids or toroidal polyhedrons with circular, polygonal or rounded-polygon cross-section whose surfaces are wholly or partially covered with electrically conductive materials.

The winding, optionally with the gapped conductor(s), may optionally be placed in or near a magnetic core. The magnetic core may be, wholly or partially, made of one or more ferromagnetic materials, which have a relative permeability greater than 1, optionally greater than 10. The ferromagnetic materials may include, but are not limited to, one or more of iron, various steel alloys, cobalt, ferrites including manganese-zinc (MnZn) and/or nickel-zinc (NiZn) ferrites, nano-granular materials such as Co—Zr—O, and powdered core materials made of powders of ferromagnetic materials mixed with organic or inorganic binders. However, the techniques and devices described herein are not limited as to the particular material of the magnetic core. The shape of the magnetic core may be: a pot core, a sheet (I core), a sheet with a center post, a sheet with an outer rim, RM core, P core, PH core, PM core, PQ core, E core, EP core, EQ core. However, the techniques and devices described herein are not limited to the particular magnetic core shape.

Gapped conductor(s) may be separated from one another, or from the winding(s), by an electrically insulating material, or a substrate or dielectric layer. An electrically insulating material, or substrate or dielectric may be any material with an electrical conductivity less than 100 kS/m, or optionally less than 1 S/m. Examples of substrate or dielectric materials include, but are not limited to, glass, alumina, PTFE, polypropylene, FR4, and ABS.

As used herein, the term “spiral” in reference to a winding refers to a winding having two or more turns of different average radii, where at least one turn surrounds one or more other turns. A “spiral,” as the term is used herein, may have a continuously and monotonically varying radius along its circumference, or may not have a continuously or monotonically varying radius.

The term “operating frequency” as used herein is the fundamental frequency of alternating current in an electromagnetic component, as opposed to harmonics of the fundamental frequency. For an electromagnetic component that is not in operation, the operating frequency is any frequency within a rated or nominal range of frequencies of operation of the electromagnetic component, which may be in a kHz range or a MHz range, for example.

Various aspects of the apparatus and techniques described herein may be used alone, in combination, or in a variety of arrangements not specifically discussed in the embodiments described in the foregoing description and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “substantially,” “approximately,” “about” and the like refer to a parameter being within 25%, optionally within 10%, optionally less than 5% of its stated value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. An electromagnetic component, comprising:
at least one winding having one or more turns; and
at least one conductor disposed in a location where the at least one winding produces an alternating magnetic field, the at least one conductor having at least one gap that inhibits current from flowing a full turn through the at least one conductor.

2. The electromagnetic component of claim 1, wherein the one or more turns comprises a first turn around an axis and a second turn around the axis and the first turn.

3. The electromagnetic component of claim 2, wherein the one or more turns have a spiral shape.

4. (canceled)

5. The electromagnetic component of claim 1, wherein the at least one conductor covers at least 75% of the at least one winding.

6. (canceled)

7. The electromagnetic component of claim 1, wherein the at least one conductor has approximately a planar shape.

8. The electromagnetic component of any of claim 1, wherein the one or more turns has a cylindrical shape or a helical shape.

9. (canceled)

10. The electromagnetic component of claim 1, wherein the at least one conductor has approximately a cylindrical shape.

11. The electromagnetic component of claim 1, wherein a distance between the at least one conductor and the at least one winding is between 1 nanometer and 25 micrometers and 1 centimeter.

12. The electromagnetic component of claim 1, wherein the at least one conductor has a thickness approximately equal to an electromagnetic skin depth of the at least one conductor at a fundamental frequency of operation of the electromagnetic component.

13. (canceled)

14. The electromagnetic component of claim 1, further comprising a magnetic core, wherein the at least one winding is within the magnetic core.

15. (canceled)

16. The electromagnetic component of claim 14, wherein the magnetic core has a magnetic flux gap and the at least one conductor is between the at least one winding and the magnetic flux gap.

17. (canceled)

18. The electromagnetic component of claim 1, wherein the at least one gap comprises a plurality of gaps.

19. The electromagnetic component of claim 1, wherein a longest dimension of the at least one gap is approximately perpendicular to a winding direction of the at least one winding at a location of the at least one winding nearest the at least one gap.

20. The electromagnetic component of claim 1, wherein the at least one conductor comprises at least one first conductor on a first side of the at least one winding, the at least one first conductor having at least one first gap, and at least one second conductor on a second side of the at least one winding, the at least one second conductor having at least one second gap.

21. The electromagnetic component of claim 20, wherein the at least one first conductor is in a region of lower magnetic field than that of the at least one second conductor.

22. The electromagnetic component of claim 20, further comprising a magnetic core having a backplate, wherein the at least one first conductor is closer to the backplate than the at least one second conductor, and the at least one first conductor is thicker than the at least one second conductor.

23. The electromagnetic component of claim 20, wherein a thickness of the at least one first conductor is greater than an electromagnetic skin depth of the at least one first conductor at a fundamental frequency of operation of the electromagnetic component, and a thickness of the at least one second conductor is less than the electromagnetic skin depth of the at least one first conductor at a fundamental frequency of operation of the electromagnetic component.

24.-26. (canceled)

27. An electromagnetic component, comprising:
at least one winding having one or more turns around an axis; and
at least one conductor at least partially covering the at least one winding, the at least one conductor including at least one high-resistance region that inhibits current from flowing a full turn around the axis through the at least one conductor.

28. (canceled)

29. The electromagnetic component of claim 27, wherein the at least one high-resistance region includes an insulator having an electrical conductivity less than 100 kS/m.

30. (canceled)

31. (canceled)

32. The electromagnetic component of claim 27, wherein the at least one conductor is configured to provide mechanical support for a vehicle.
